(19) United States
(12) Patent Application Publication
(10) Pub. No.: US 2008/0192150 A1
(43) Pub. Date: Aug. 14, 2008

(54) Receiving Apparatus

(76) Inventor: Seung Gwang Ahn, Gwangju (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/910,181

(22) PCT Filed: Aug. 31, 2006
(86) PCT No.: PCT/KR2006/003441

§ 371 Date: Sep. 28, 2007

(30) Foreign Application Priority Data
Sep. 6, 2005 (KR) 10-2005-0082839
Aug. 8, 2006 (KR) 10-2006-0074921

(51) Int. Cl. H04N 5/50

(52) U.S. Cl. 348/731; 348/E05.097

(57) ABSTRACT

A receiving apparatus is provided. The receiving apparatus includes: a tuner receiving an RF signal and converting a frequency of the RF signal into an intermediate frequency; a demodulator converting a signal of the intermediate frequency outputted from the tuner into a transport stream; and an MPEG decoder separating the transport stream outputted from the demodulator into a video signal and an audio signal for decoding. The tuner, the demodulator, and the MPEG decoder are modulized and formed on one circuit board.

### TECHNICAL FIELD

The present invention relates to a receiving apparatus.

### BACKGROUND ART

A receiving apparatus includes a tuner receiving a radio frequency (RF) signal and converting the RF signal into an intermediate frequency, a demodulator converting the intermediate frequency converted from the tuner into a transport stream (TS), and an MPEG decoder decoding a signal outputted from the demodulator and separating the signal into a video signal and an audio signal.

The receiving apparatus is widely used in various electronic appliances such as a television, a set top box, and a DVD-R. On the other hand, original signals that will be processed are required to be inputted into the various electronic appliances, respectively. Additionally, a broadcasting signal received through the tuner is decoded in the MPEG decoder, and then converted into an appropriate signal format for each electronic appliance.

At this point, the MPEG decoder has different characteristics according to various kinds of an electronic appliance or different manufacturers, and also is separately manufactured and assembled to be connected to the tuner and the demodulator.

Accordingly, the tuner, the demodulator, and the MPEG decoder can not be integrated in one module, and thus are mounted on separate circuit boards in an electronic appliance.

Therefore, the volume of the receiving apparatus increases, and also manufacturing cost rises due to difficulty of mass production.

### DISCLOSURE OF INVENTION

### Technical Problem

The present invention provides a receiving apparatus that is modulized with a tuner, a demodulator, and an MPEG decoder.

The present invention provides a receiving apparatus that is used in various electronic appliances of different manufactures.

The present invention provides a receiving apparatus integrating a tuner, a demodulator, and an MPEG decoder into one chip.

### Technical Solution

In the embodiment of the present invention, there is provided a receiving apparatus including: a tuner receiving an RF signal and converting a frequency of the RF signal into an intermediate frequency; a demodulator converting a signal of the intermediate frequency outputted from the tuner into a transport stream; and an MPEG decoder separating the transport stream outputted from the demodulator into a video signal and an audio signal for decoding. The tuner, the demodulator, and the MPEG decoder are modulized and formed on one circuit board.

In the embodiment of the present invention, there is provided a receiving apparatus including: a first side of a circuit board having a tuner, a demodulator, and an MPEG decoder; and a second side of the circuit board having a clock generator, a regulator, an audio DAC (digital to analog converter), and a memory unit. The MPEG decoder comprises a plurality of video interfaces connected to one selected from a plurality of electronic appliances to output a video signal of an appropriate format to the selected one.

In the embodiment of the present invention, there is provided a receiving apparatus including: a tuner receiving an RF signal and converting a frequency of the RF signal into an intermediate frequency; a demodulator converting a signal of the intermediate frequency outputted from the tuner into a transport stream; and an MPEG decoder separating the transport stream outputted from the demodulator into a video signal and an audio signal for decoding. The tuner, the demodulator, and the MPEG decoder are formed as one chip.

### ADVANTAGEOUS EFFECTS

A receiving apparatus of the present invention can be reduced to the minimum volume and compatible with various appliances to allow mass production. Therefore, manufacturing cost reduces.

### BRIEF DESCRIPTION OF THE DRAWINGS

FIG. 1 is a block diagram of a receiving apparatus according to a first embodiment of the present invention;

FIGS. 2 and 3 are views of a receiving apparatus formed on a circuit board according to the first embodiment of the present invention; and

FIG. 4 is a block diagram of a receiving apparatus according to a second embodiment.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

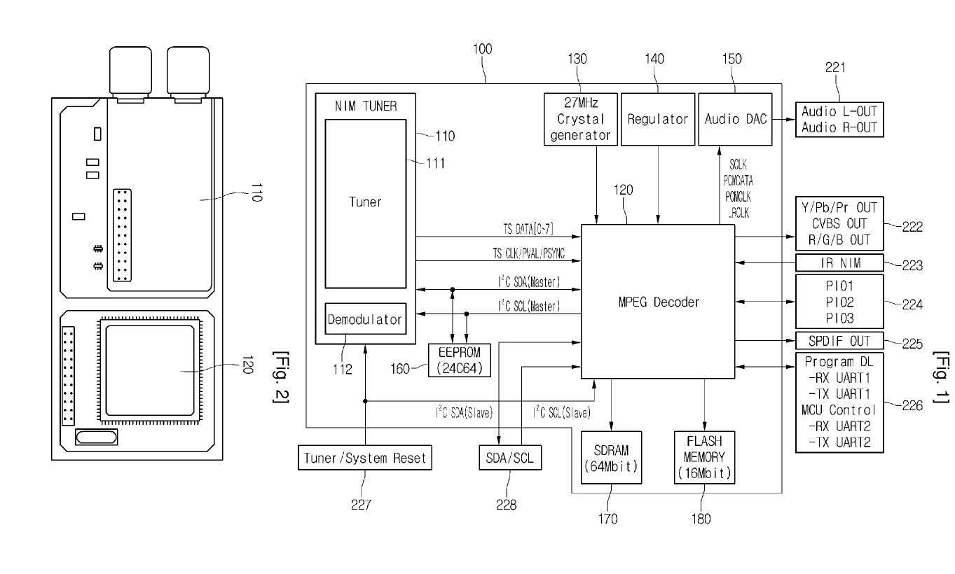

FIG. 1 is a block diagram of a receiving apparatus according to a first embodiment of the present invention.

Referring to FIG. 1, the receiving apparatus 100 is modulized and mounted on one circuit board.

First, there is provided a network interface module (NIM) that is modulized with a tuner 111 and a demodulator 112. The tuner 111 receives an RF signal and converts the RF signal into an intermediate frequency. The demodulator 112 converts the intermediate frequency outputted from the tuner 111 into a transport stream.

The NIM tuner 110 is connected to an MPEG decoder 120 to transmit the transport stream through signals such as TS DATA, TS Clock (TS CLK), parallel validity (PVAL), and parallel Sync (PSYNC).

The MPEG decoder 120 receives the transport stream from the NIM tuner 110 and separates the transport stream into a video signal and an audio signal for decoding.

The NIM tuner 110 is connected to the MPEG decoder 120 through an I²C communication line for communications. An electrically erasable programmable read only memory (EEPROM) 160 can be connected to the I²C communication line, and required data are stored. For example, data such as channel information, software version information, time information, and password can be stored in the EEPROM 160.

On the other hand, the MPEG decoder 120 is electrically connected to a synchronous dynamic random access memory (SDRAM) 170 and flash memory 180.

A video signal and an audio signal inputted into the MPEG decoder 120, or decoded digital video and audio signals can be temporarily stored in the SDRAM 170.

The flash memory 180 includes a boot region and a program region. Data that are related to operations of the receiving apparatus 100 is stored in the boot region, and data that are related to a system operation of the receiving apparatus 100 are stored in the program region.

A 27 MHz crystal generator 130 and a regulator 140 are connected to the MPEG decoder 120. The 27 MHz crystal generator 130 as a clock generator supplies a clock signal into the MPEG decoder 120. The regulator 140 converts an inputted voltage into an appropriate voltage to supply the voltage into the MPEG decoder 120.

Additionally, the MPEG decoder 120 is connected to an audio digital to analog converter (DAC) 150. The audio DAC 150 converts a decoded digital audio signal into an analog signal for outputting.

The receiving apparatus 100 according to the first embodiment has a plurality of interfaces that are connected to external devices.

An audio interface 221 includes Audio L-OUT and Audio R-OUT to output the audio signals that are converted from the audio DAC 150.

A video interface 222 includes Y/Pb/Pr OUT, composite video banking sync (CVBS) OUT, and R/G/B OUT in various format to output the video signal outputted from the MPEG decoder 120 into a plurality of electronic appliances.

For example, the Y/Pb/Pr OUT and the CVBS OUT can be connected to a television and a set top box, respectively. The R/G/B OUT can be connected to a television or a DVD-R.

An infrared interface 223 includes an infrared network interface module (IR NIM) inputting an infrared signal inputted from outside into the MPEG decoder 120. When the receiving apparatus 100 is applied to the DVD-R etc, the MPEG decoder 120 serves as a main controller or a micro controller. Therefore, a signal of a remote control unit is required to be inputted into the MPEG decoder 120.

An additional interface 224 includes PIO1 (Port In/Out 1), PIO2 (Port In/Out 2), and PIO3 (Port In/Out 3) that can be appropriately used according to various electronic appliances having the receiving apparatus 100 or different manufacturers.

A digital interface 225 includes sony/Philips digital interface (SPDIF) OUT that connects a digital audio signal with a speaker.

A first control interface 226 can include RX UART1, and TX UART1 providing a program download (DL) function to input necessary programs according to various electronic appliances having the receiving apparatus 100, or can include RX UART2 and TX UART2 providing a micro controller unit (MCU) control function to connect to a microcomputer of an external electronic appliance for input/output of a control signal.

The program inputted through the first control interface 226 can be stored in the flash memory 180. Since the first control interface 226 is electrically connected to a microcomputer of a television, the receiving apparatus 100 can be controlled by the microcomputer of the television.

A reset interface 227 includes a tuner/system reset resetting the NIM tuner 110 and the MPEG decoder 120. A second control interface 228 includes SDA/SCL controlling the MPEG decoder 120 in a slave state.

In the receiving apparatus 100, the tuner 111, the demodulator 112, and the MPEG decoder 120 are modulized and formed on one circuit board. Additionally, a plurality of video interfaces and a plurality of control interfaces are formed to be compatible with a plurality of electronic appliances made by different manufacturers.

The control interface can include a download interface storing appropriate programs according to kinds of an electronic appliance having the receiving apparatus 100, or can include a plurality of control signal input/output interfaces receiving a control instruction from an electronic appliance having the receiving apparatus 100.

Moreover, a plurality of audio interfaces can be formed, and also an infrared interface can be formed to receive a control instruction of a user.

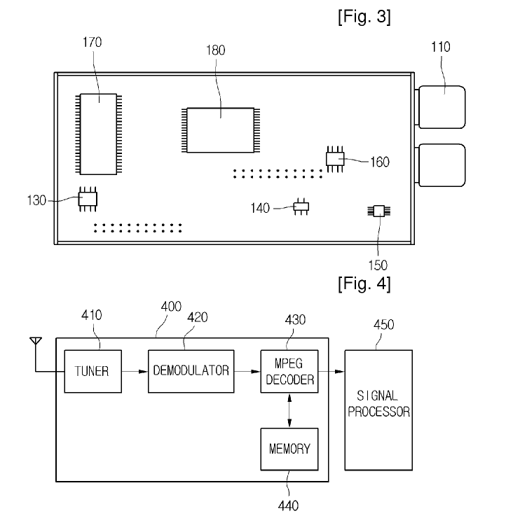

FIGS. 2 and 3 are views of the receiving apparatus 100 formed on a circuit board according to the first embodiment of the present invention.

As illustrated in FIGS. 2 and 3, a NIM tuner 110 and a MPEG decoder 120 are formed on a first side of the circuit board. SDRAM 170, a 27 MHz crystal generator 130, flash memory 180, EEPROM 160, a regulator 140, and an audio DAC 150 can be formed on a second side of the circuit board.

In the receiving apparatus 100, the tuner 110, the demodulator 112 and the MPEG decoder 120, which were manufactured and mounted as additional units in a plurality of respectively-mounting electronic appliances, are modulized on one circuit board.

Additionally, the receiving apparatus 100 includes a plurality of interfaces to be compatible with a plurality of electronic appliances.

Accordingly, the volume that the receiving apparatus 100 occupies is minimized, and manufacturing cost can be reduced due to the possibility of mass production.

FIG. 4 is a block diagram of a receiving apparatus according to a second embodiment.

A receiving apparatus 400 according to the second embodiment has functions identical to that of the receiving apparatus 100 in FIG. 1.

Components of the receiving apparatus 100 in FIG. 1 are formed on one circuit board. However, components the receiving apparatus 400 in FIG. 4 are integrated as one chip. Therefore, the size of the receiving apparatus 400 can be more minimized than that of the receiving apparatus 100.

On the other hand, like the receiving apparatus 100 of FIG. 1, the receiving apparatus 400 of FIG. 4 can be compatible with a plurality of electronic appliances made by different manufactures. However, configuration that is different from FIG. 1 will be described in more detail.

Referring to FIG. 4, the receiving apparatus 400 is integrated as one chip and mounted on a circuit board.

First, the receiving apparatus 400 includes a tuner 410 receiving an RF signal and converting the RF signal into an intermediate frequency, and a demodulator 420 converting the intermediate frequency outputted from the tuner into a transport stream.

The demodulator 420 is connected to an MPEG decoder 430 to transmit the transport stream. The MPEG decoder 430 receives the transport stream to separate the transport stream into a video signal and an audio signal for decoding.

The MPEG decoder 430 is connected to memory 440. The memory 440 includes EEPROM, SDRAM, and flash memory.

For example, data such as channel information, software version information, time information, and password can be stored in the EEPROM. A video signal and an audio signal inputted into the MPEG decoder 430, or decoded digital video and audio signals can be temporarily stored in the SDRAM.

The flash memory includes a boot region and a program region. Data that are related to operations of the receiving apparatus 400 is stored in the boot region, and data that are related to a system operation of the receiving apparatus 400 are stored in the program region.

Additionally, the MPEG decoder 430 is connected to a signal processor 450 of an electronic appliance to transmit the decoded video and audio signals.

In the receiving apparatus 400, the tuner 410, the demodulator 420, and the MPEG decoder 430 are integrated as one chip, and also the memory 440 can be additionally integrated into the one chip.

The receiving apparatus 400 is integrated into one chip to decode video and audio signals, and then to transmit the decoded signals into an electronic appliance.

The receiving apparatus 400 is integrated into one chip so that space that the receiving apparatus 400 occupies in an electronic appliance is reduced drastically. Especially, the receiving apparatus 400 can be designed without being influenced from other electronic components of an electronic appliance or a circuit design. Therefore, the receiving apparatus 400 can be easily designed without considering a design of an electronic appliance.

### INDUSTRIAL APPLICABILITY

The present invention can be applied to various electronic appliances that utilize a receiving apparatus having a tuner, a demodulator, and an MPEG decoder.

1. A receiving apparatus comprising:
a tuner for receiving an RF (radio frequency) signal and converting a frequency of the RF signal into an intermediate frequency;
a demodulator for converting a signal of the intermediate frequency outputted from the tuner into a transport stream; and
an MPEG decoder for separating the transport stream outputted from the demodulator into a video signal and an audio signal for decoding,
wherein the tuner, the demodulator, and the MPEG decoder are modulized and provided on one circuit board.

2. The receiving apparatus according to claim 1, wherein the tuner and the demodulator are incorporated into a modulized NIM (network interface module) tuner.

3. The receiving apparatus according to claim 1, wherein the MPEG decoder comprises a plurality of video interfaces, wherein a selected video interface of the plurality of video interfaces is capable of being connected to an electronic appliances to output a video signal of an appropriate format to the electronic appliance.

4. The receiving apparatus according to claim 1, wherein the MPEG decoder comprises a plurality of audio interfaces, wherein a selected audio interface of the plurality of audio interfaces is capable of being connected to an electronic appliance to output an audio signal of an appropriate format to the electronic appliance.

5. The receiving apparatus according to claim 1, wherein the MPEG decoder comprises a plurality of control interfaces, wherein a selected control interface of the plurality of control interfaces is capable of being connected to an electronic appliance to output a control signal of the electronic appliance.

6. The receiving apparatus according to claim 1, wherein the MPEG decoder comprises an infrared interface to be controlled in response to a control signal inputted from a remote control unit.

7. The receiving apparatus according to claim 1, wherein the MPEG decoder comprises a program input interface to input an appropriate program to a selected one of a plurality of electronic appliances.

8. A receiving apparatus comprising:
a first side of a circuit board having a tuner, a demodulator, and an MPEG decoder; and
a second side of the circuit board having a clock generator, a regulator, an audio DAC (digital to analog converter), and a memory unit,
wherein the MPEG decoder comprises a plurality of video interfaces to output a video signal of an appropriate format to a selected electronic appliance.

9. The receiving apparatus according to claim 8, wherein the tuner and the demodulator are incorporated into a modulized NIM tuner.

10. The receiving apparatus according to claim 8, wherein the MPEG decoder comprises a plurality of audio interfaces wherein a selected audio interface of the plurality of audio interfaces is capable of being connected to an electronic appliance to output an audio signal of an appropriate format into the electronic appliance.

11. The receiving apparatus according to claim 8, wherein the MPEG decoder comprises a plurality of control interfaces wherein a selected control interface of the plurality of control interfaces is capable of being connected to an electronic appliance to output a control signal of the electronic appliance.

12. The receiving apparatus according to claim 8, wherein the MPEG decoder comprises an infrared interface to be controlled in response to a control signal inputted from a remote control unit.

13. The receiving apparatus according to claim 8, wherein the MPEG decoder comprises a program input interface to input an appropriate program to a selected one of a plurality of electronic appliances.

14. A receiving apparatus comprising:
a tuner for receiving an RF signal and converting a frequency of the RF signal into an intermediate frequency;
a demodulator for converting a signal of the intermediate frequency outputted from the tuner into a transport stream; and
an MPEG decoder for separating the transport stream outputted from the demodulator into a video signal and an audio signal for decoding,
wherein the tuner, the demodulator, and the MPEG decoder are formed as one chip.

15. The receiving apparatus according to claim 14, further comprising a memory integrated into the one chip.

16. The receiving apparatus according to claim 14, wherein the MPEG decoder comprises a plurality of video interfaces wherein a selected video interface of the plurality of video interfaces is capable of being connected to an electronic appliance to output a video signal of an appropriate format into the electronic appliance.

17. The receiving apparatus according to claim 14, wherein the MPEG decoder comprises a plurality of audio interfaces, wherein a selected audio interface of the plurality of audio interfaces is capable of being connected to an electronic appliance to output an audio signal of an appropriate format into the electronic appliance.

18. The receiving apparatus according to claim 14, wherein the MPEG decoder comprises a plurality of control interfaces, wherein a selected control interface of the plurality of control inter faces is capable of being connected to an electronic appliance to output a control signal of the electronic appliance.

19. The receiving apparatus according to claim 14, wherein the MPEG decoder comprises a program input interface to input an appropriate program to a selected one of a plurality of electronic appliances.
